(19) United States
(12) Patent Application Publication
(10) Pub. No.: US 2008/0079941 A1
(43) Pub. Date: Apr. 3, 2008

(54) Differential Geomety-Based Method and Apparatus for Measuring Polarization Mode Dispersion Vectors in Optical Fibers

(75) Inventors: Hui Dong, Singapore (SG); Yandong Gong, Singapore (SG); Chao Lu, Singapore (SG)

Correspondence Address: INTELLECTUAL PROPERTY / TECHNOLOGY LAW, PO BOX 14329, RESEARCH TRIANGLE PARK, NC, 27709, US

(73) Assignee: AGENCY FOR SCIENCE, TECHNOLOGY AND RESEARCH, Centros (SG)

(21) Appl. No.: 11/574,797

(22) PCT Filed: Sep. 7, 2005
(86) PCT No.: PCT/SG05/00306

§ 371 Date: Aug. 15, 2007

Related U.S. Application Data
(60) Provisional application No. 60/608,005, filed on Sep. 7, 2004.

(51) Int. Cl. G01M 11/02

(52) U.S. Cl. 356/365

(57) ABSTRACT

A method and apparatus are provided for determining the first and second order polarization mode dispersion (PMD) vectors of an optical device, such as a single mode optical fiber, using only a single input polarization state. This is achieved by passing light beams having a fixed polarization state and frequencies that vary over a range through the optical device that is being tested. The output polarization states of the light beams that have passed through the optical device are measured, and used to form a curve in Stokes space on a Poincare sphere. The shape of this curve is used to approximate the first and second order (and possibly higher order) PMD vectors, using formulas based on differential geometry.

This application claims the benefit of U.S. Provisional Application No. 60/608,005, filed Sep. 7, 2004. The present invention relates generally to fiber optics, and more specifically to the measurement of polarization mode dispersion vectors in optical fibers.

### BACKGROUND OF THE INVENTION

Polarization mode dispersion (PMD) is an optical effect that occurs in single-mode optical fibers. In such fibers, light from a transmitted signal travels in two perpendicular polarizations (modes). Due to a variety of imperfections in the fiber, such as not being perfectly round, as well as microbends, microtwists, or other stresses, birefringence may occur in the fiber. This birefringence causes the two polarizations to propagate through the fiber at slightly different velocities, resulting in their arriving at the end of the fiber at slightly different times, as seen in FIG. 1. Thus, fibers are said to have a “fast” axis and a “slow” axis. This difference in arrival times is one effect of PMD.

As shown in FIG. 1, an input signal 102 to a fiber 100 can be represented as having two polarization modes 104 and 106, in perpendicular directions along a fast axis 108 and a slow axis 110 of the fiber 100. Due to birefringence, when travelling over the length of the fiber 100, the mode 104 along the fast axis 108 arrives at the end of the fiber 100 slightly before the mode 106 along the slow axis 110. The difference in times of arrival is called the differential group delay (DGD), and may be represented in later equations as Δτ.

In any real fiber, the birefringence will vary across the length of the fiber. Thus, the fiber may be modelled as a large number of sections having randomly varying fast and slow axes. The fiber as a whole will have a special pair of perpendicular polarizations at the input and the output called the principal states of polarization (PSP). To first order in frequency, light that is input into the fiber polarized along a PSP will not change its polarization at the output. The PSPs have the minimum and maximum mean time delays across the fiber, and the overall DGD for the fiber is the difference between the delays along the PSPs. The DGD grows approximately in proportion to the square root of the length of the fiber. Depending on the type of fiber that is used, the mean DGD for a 500 km fiber will be between approximately 1 and 50 picoseconds.

Related frequency-based effects of PMD are also present. Generally, for a fixed input polarization, the output polarization will vary with the frequency of the input light. In the absence of high-order PMD effects, with an input beam having a fixed polarization, the polarization of the output beam will vary with the frequency of the input in a periodic manner.

Polarization states may be conveniently represented as points on a Poincaré sphere, which is a sphere in Stokes space where each polarization state maps to a unique point on the Poincaré sphere. Stokes space is a three-dimensional vector space based on the last three Stokes parameters:

S₁=Ip cos2ψ cos2ψ (1)

S₂=Ip sin2ψ cos2ψ (2)

S₃=Ip sin2x (3)

Where:
I is the intensity;
p is the fractional degree of polarization;
ψ is the azimuth angle of the polarization ellipse; and
x is the ellipticity angle of the polarization ellipse.

In Stokes space, the Poincaré sphere is the spherical surface occupied by completely polarized states (i.e., p=1). FIG. 2 shows a Poincaré sphere 200, with axes S₁, S₂, and S₃, corresponding to the Stokes parameters described above. The “top” point 202 on the S₃ axis of the sphere 200 has Stokes space coordinates (0,0,1), and represents a right-hand circular polarization state. The “bottom” point 204 on the S₃ axis of the sphere 200 has coordinates (0,0,−1), and represents a left-hand circular polarization. The point 206 on the S₁ axis of the sphere 200 has coordinates (1,0,0), and represents a horizontal linear polarization state. The point 208 on the S₁ axis of the sphere 200 has coordinates (−1,0,0), and represents a vertical linear polarization state. Finally, the points 210 and 212 on the S₂ axis of the sphere 200 have coordinates (0,1,0) and (0,−1,0), and a represent a 45° linear polarization state and a −45° linear polarization state, respectively. As can be seen in FIG. 2, all linear polarization states lie around the circumference of the Poincaré sphere 200, and circular polarization states lie at the poles along the S₃ axis. Other points on the Poincaré sphere 200 represent elliptical polarization states.

The output polarizations that vary with frequency may be mapped onto the surface of a Poincaré sphere. Due to PMD, when the input polarization is fixed, and the wavelength of the light is varied, the output polarization states will trace a curve on the surface of the Poincaré sphere. In the absence of high order PMD effects, the output polarization states will trace a circular path on the surface of a Poincaré sphere as the input wavelength is varied. The DGD gives the rate of change of the circle with respect to input frequency. Due to the presence of high-order PMD effects, the actual curve traced on the surface of the Poincaré sphere when the wavelength is varied will typically be more complex.

The first order effects of PMD for a length of fiber may be represented using a single three-dimensional vector in Stokes space. This vector is known as a first order PMD vector, or Ω. The time effects of PMD are represented by the magnitude of the first order PMD vector, which is equal to the DGD. Therefore, the magnitude of the first order PMD vector also describes the rate of rotation of the polarization as the input frequency is varied. The direction of the PMD vector points to a location on the Poincare sphere representing the fast principal axis (i.e., the “fast” axis of the PSPs).

Generally, the PMD of a fiber (or other optical device) may be described by one or more PMD vectors, including a first order PMD vector, and, possibly, a second order and higher order PMD vectors. The second order PMD vector is the frequency derivative of the first order PMD vector, and generally has terms that represent a polarization dependent chromatic dispersion in the fiber, and a frequency dependent rotation of the PSPs. Higher order PMD vectors are simply further derivatives of the first order PMD vector.

PMD is one of the most important factors limiting the performance of high-speed optical communications systems. Accurate measurements of PMD may be used to determine the bandwidth of a length of fiber, and to attempt to compensate for the PMD. Thus, many techniques have been used to measure PMD. Most of these measure only the DGD, which is the magnitude of the first order PMD vector, providing only limited accuracy. A few known techniques measure the first order and, in some cases, the second and higher order PMD vectors. These techniques include the Poincaré Sphere Technique (PST), Jones Matrix Eigenanalysis (JME), the Müller Matrix Method (MMM), and a method described by C. D. Poole and D. L. Favin in their paper, entitled “Polarization-mode Dispersion Measurements Based on transmission spectra Through a Polarizer”, published in IEEE Journal of Lightwave Technology, Vol. 12, No. 6, June 1994, pp. 917-929 (CDP).

The JME technique uses eigenvalues and eigenvectors to compute the PMD vectors. At a first fixed frequency, light with three different known polarization states (e.g., linear polarization with 0°, 45°, and 90° orientations) is input into the fiber, and the output polarization states are measured. These output polarization states are used to form a 2×2 “Jones transfer matrix”, that describes the transformation of the input polarization state to the output polarization state at the first fixed frequency. The same three polarization states are then input into the fiber using light with a second fixed frequency. The output polarization states are used to compute a second Jones transfer matrix, describing the transformation of the input polarization state to the output polarization state at the second frequency. These two matrices are then used to compute a difference matrix that describes the change in the output polarization state as the frequency varies from the first frequency to the second frequency. The eigenvectors of the difference matrix are the PSPs, and the eignevalues may be use to compute the DGD. Generally, the difference matrix may be used to compute the first and second order PMD vectors.

The Müller Matrix Method (MMM) is similar to the JME technique, but is able to compute the PMD vectors using only two input polarizations for each of two frequencies. The MMM carries out these computations using Müller matrices, rather than Jones transfer matrices, and assumes the absence of polarization dependent loss (PDL). This can lead to inaccuracies in the MMM, due to the presence of PDL.

The method described by C. D. Poole and D. L. Favin (CDP) also uses measurements taken at two input polarization states. The method is carried out by counting the number of extrema (i.e., maxima and minima) per unit wavelength interval in the transmission spectrum measured through a polarizer placed at the output of a test fiber.

One difficulty with these methods is that they require that measurements be taken with two or more input polarization states, and varying frequencies. Because of this, taking the measurements is relatively slow. The long measurement times associated with these methods can cause difficulties because over time, the output polarization state for a fixed input polarization state and frequency can vary in a long fiber. Thus, by the time the measurement is taken, it may already be inaccurate. Additionally, errors can be introduced due to the changes in the input polarization states and frequency adjustments. These errors can introduce further measurement inaccuracies.

The Poincaré Sphere Technique (PST) requires only one input state of polarization, so it can be performed faster than JME, MMM, or CDP. The calculations of the PST are carried out entirely in Stokes space, based on the frequency derivatives of the measured output polarization states on the Poincaré sphere. Small changes in input frequency cause rotation of the output polarization state on the Poincaré sphere. Based on input frequencies and measurements of the output polarization state, the angles of rotation are estimated, and used to compute the DGD and PSPs. The PST, while relatively fast, since only one input polarization state is needed, can only measure the first order PMD vector, and cannot measure the second order or higher order PMD vectors. This limits its accuracy and utility for making PMD measurements in many high speed communications applications.

What is needed in the art is a high-speed measurement technique for PMD that is able to determine the first order, second order, and (if needed) higher order PMD vectors.

### SUMMARY OF THE INVENTION

The present invention provides a method and apparatus for determining the first and second order PMD vectors of an optical device, such as a single-mode optical fiber, using only a single input polarization state. Advantageously, this permits the measurements to be made relatively quickly, decreasing the likelihood of error due to variation over time of the output polarization state of an optical fiber.

In one embodiment of the invention, this is achieved by passing light beams that have the same fixed polarization state, and frequencies that vary over a range through the optical device that is being tested. The output polarization states of the light beams that have passed through the optical device are measured, and used to form a curve in Stokes space on a Poincaré sphere. In accordance with the invention, the shape of this curve may be used to approximate the first and second order (and possibly higher order) PMD vectors.

The first and second order PMD vectors are computed from the curve using formulas derived using techniques from differential geometry. As described in detail below, the first order PMD vector may be computed using the magnitude of the tangent of the curve, the curvature, and the binormal vector. The second order PMD vector may be computed using the magnitude of the tangent of the curve, the curvature, the torsion, the binormal vector, and the principal normal vector of the curve.

### BRIEF DESCRIPTION OF THE DRAWINGS In the drawings, like reference characters generally refer to the same parts

Throughout the different views. The drawings are not necessarily to scale, emphasis instead generally being placed upon illustrating the principles of the invention. In the following description, various embodiments of the invention are described with reference to the following drawings, in which:

FIG. 1 shows an example of differential group delay (DGD) due to polarization mode dispersion (PMD);

FIG. 2 shows a Poincaré sphere;

FIG. 3 is a block diagram of an apparatus for measuring the PMD and computing the PMD vectors in accordance with the invention;

FIG. 4 shows a curve on the Poincaré sphere, formed by plotting the output polarization states for a range of input frequencies;

FIG. 5 is a flowchart showing a method for computing the first and second order PMD vectors in accordance with an embodiment of the invention;

FIG. 6 is a graph showing an example of a first order PMD vector computed using the methods of the invention; and

FIG. 7 is a graph showing an example of a second order PMD vector computed using the methods of the invention.

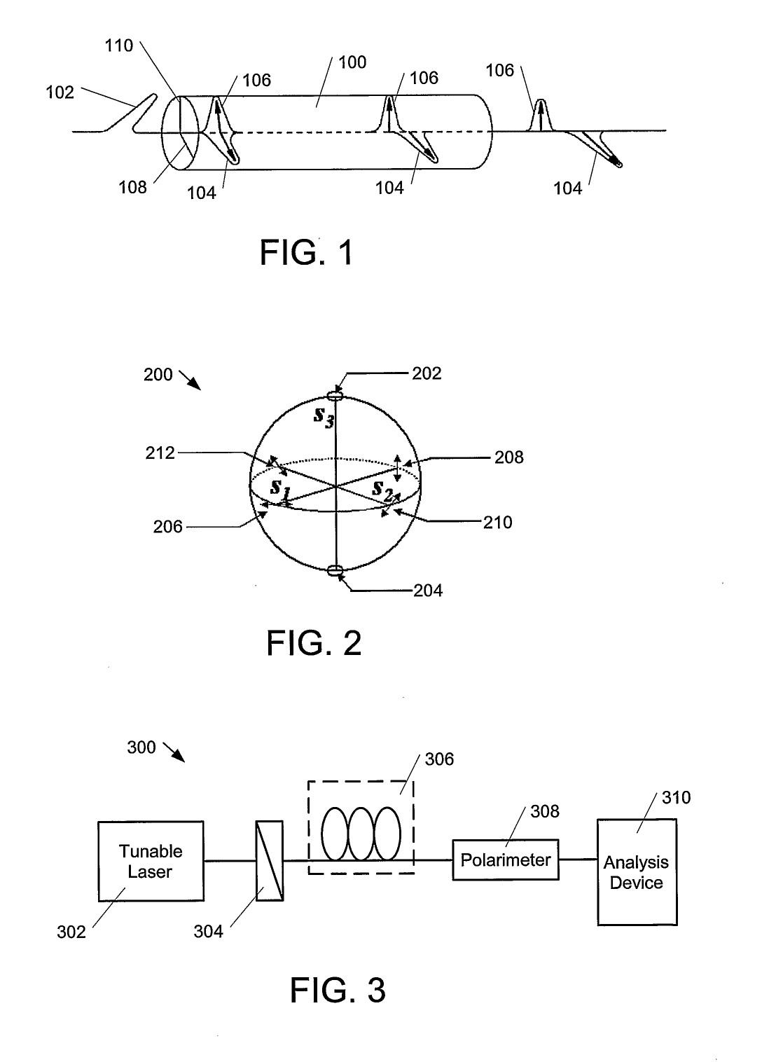

### DETAILED DESCRIPTION

The present invention relates to determining the first and second order PMD vectors (and, possibly, higher order PMD vectors) of an optical device, such as a single-mode optical fiber, using only a single input polarization state. Advantageously, because only one polarization state is used, the measurements can be performed more rapidly than prior art methods such as Jones matrix eigenanalysis or the Müller matrix method, while producing results that similar in accuracy. Because the methods of the present invention may be performed rapidly, their results may be more accurate than prior art methods, because the output polarization state for a long length of optical fiber may vary over the amount of time that it takes to perform prior art measurements.

FIG. 3 shows a measurement apparatus that may be used in accordance with the present invention. Measurement apparatus 300 includes a tunable laser source 302, a fixed polarizer 304, the device under test (DUT) 306, a polarimeter 308, and an analysis device 310.

The tunable laser source 302, which in some embodiments may be controlled by the analysis device 310 or by a separate control device (not shown), provides light at a selected frequency that may be varied over a predetermined range. This light is then polarized by the fixed polarizer 304, to provide a predetermined polarization state. Because the methods of the present invention require only a single polarization state for the input light, it is not necessary to provide the ability to vary the polarization imparted by the fixed polarizer 304. This simplifies the test setup, and removes adjustment of the input polarization as a possible source of error during testing. It should be noted that some tunable lasers are able to provide light with a predetermined, fixed polarization. If such a tunable laser is used for the tunable laser source 202, the fixed polarizer 204 is not needed.

Next, the polarized light is sent through the device under test (DUT) 306, and the output state of polarization- is measured by the polarimeter 308. The polarization information provided by the polarimeter 308 is then provided to the analysis device 310, which may be a computer, for analysis. When the analysis device 310 has received output polarization data for enough frequencies of light, the analysis device 310 determines the first and second order PMD vectors, in accordance with the methods of the present invention.

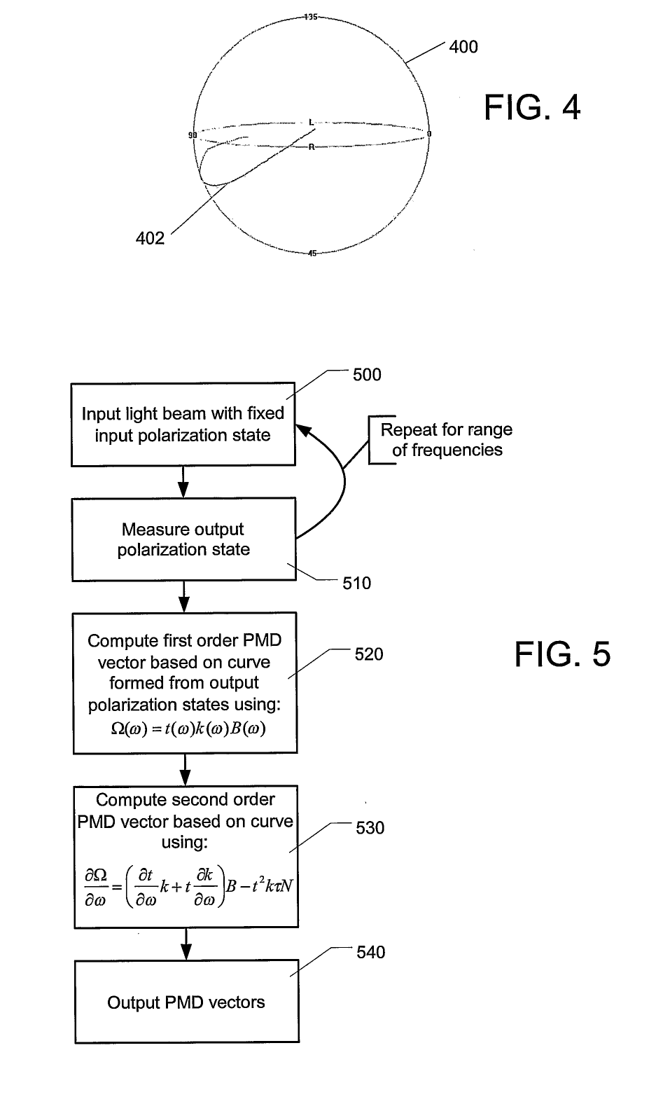

Each of the output polarizations that is provided to the analysis device 310 may be represented as a point on the Poincare sphere. With inputs across a range of frequencies, the collection of output points may be used to form a curve on the Poincaré sphere. In the absence of second order or higher order PMD, this curve will be a circle (or a portion of a circle). If second order or higher PMD effects are present, the curve will have a more complex shape, such as is shown in FIG. 4.

It will be understood that the measurement apparatus shown in FIG. 3 is similar to apparatus used with other methods, such as the Poincaré sphere technique (PST), described above. A similar apparatus is also used with Jones matrix eigenanalysis (JME) and the Müller matrix method (MMM), but in both of these methods, it is necessary to change the input polarization state, so the fixed polarizer 304 would need to be replaced. Additionally, the methods used in the analysis device 310 of the present invention differ from those used in other methods, as will be described below.

FIG. 4 shows an example of a curve 402 on a Poincaré sphere 400. The curve 402 is formed by measuring the output polarization states of a single-mode fiber, where the input light has a fixed polarization state, and a frequency that varies over a predetermined range. In the example shown in FIG. 4, the wavelength of the input light (which is inversely related to frequency) was varied over the range from 1545 nm to 1555 nm. As can be seen, the curve is not circular, so second order or higher order PMD effects are present.

In accordance with the invention, the curve formed on a Poincaré sphere, such as is shown in FIG. 4, may be analyzed as a space curve, using techniques from differential geometry, to determine the first and second order PMD vectors. Once the measurements are taken to form the curve, the analysis may be rapidly performed using an analysis device, such as a computer. The following discussion explains the nature of the analysis in accordance with the invention.

Generally, when the input state of polarization is fixed, and the frequency of light input to a single-mode optical fiber is varied, the output polarization of the light will vary according to:

$$\frac{\partial S}{\partial ω} = Ω \times S \qquad ( 4 )$$

Where:
S is a vector representing the state of polarization in Stokes space;
ω is the angular frequency; and
Ω is the first-order PMD vector.

Assuming that there is no depolarization or polarization dependent loss, then |S|=1, and all polarization states may be represented on the surface of the Poincaré sphere. As discussed above, if there is no second or higher order PMD, then the curve traced on the surface of the Poincaré sphere is circular, and the DGD (i.e., Δτ), which is the magnitude of first-order PMD vector, is the rate of change of the circular path. In general, we can write:

$$\vert Ω \vert = Δ τ = \frac{Δ φ}{Δ ω} \qquad ( 5 )$$

Where:
Δτ is the DGD;
Δψ is the change in the phase shift; and
Δω is the change in angular frequency.

As noted above, if there is second order or higher order PMD, the curve has a more complicated shape, such as is shown in FIG. 4. To analyze this curve, in accordance with the present invention, principles of differential geometry may be applied. Generally, in differential geometry, a space curve, such as the curve formed on the Poincaré sphere by the output polarization states, is parameterized by arc length l. Here, the arc length may be expressed as:

$$l = {\int }_{{ω}_{0}}^{ω} \vert \frac{\partial S}{\partial ω} \vert d ω \qquad ( 6 )$$

Where:
l is the arc length; and
ω₀ is the starting angular frequency.

Parameterizing by arc length, and applying the general techniques of differential geometry permits characteristics of the curve to be expressed in terms of its curvature, its torsion, and other geometric properties. As background, the curvature of a space curve measures the deviance of the curve from being a straight line. Thus, a straight line has a curvature of zero, and a circle has a constant curvature, which is inversely proportional to the radius of the circle. The torsion of a curve is a measure of its deviance from being a plane curve (i.e., from lying on a plane known as the “osculating plane”). If the torsion is zero, the curve lies completely in the osculating plane.

If we assume that the portion along the tangent direction of the second order or higher order PMDs is much less than the square root of the first order PMD, which is a valid assumption in most cases for all of the fiber and optical components used in high-speed communication systems, then, based on Eq. 5, Eq. 6, and the definition of curvature, it can be deduced that:

$$\vert Ω ( ω ) \vert = {lim}_{Δ ω \to 0} \frac{k ( ω ) Δ l}{Δ ω} = k ( ω ) t ( ω ) \qquad ( 7 )$$

Where:
k(ω) is the curvature; and
t(ω) is the magnitude of the tangent,

$$t ( ω ) = \vert \frac{\partial S}{\partial ω} \vert .$$

Generally, based on this, the first order PMD vector can be expressed as:

Ω(ω)=t(ω)k(ω)B(ω) (8)

Where:
B(ω) is the unit binormal vector.

By way of background, the unit binormal vector referenced in Eq. 8 is a unit vector that is perpendicular to both the unit tangent vector along the curve and the principal normal vector, which is a unit vector that is perpendicular to the unit tangent vector. Generally, the tangent is the first derivative of the curve, the principal normal is the first derivative of the tangent, and the binormal is the cross product of the tangent and the principal normal.

Since Eq. 8 provides an expression for the first order PMD vector, the second order PMD vector may be computed by taking the derivative of the expression for the first order PMD with respect to angular frequency. Taking the derivative of the expression in Eq. 8 gives:

$$\frac{\partial Ω}{\partial ω} = ( \frac{\partial t}{\partial ω} k + t \frac{\partial k}{\partial ω} ) B + tk \frac{\partial B}{\partial ω} \qquad ( 9 )$$

This can be simplified based on the Frenet formulas, which provide that for a unit speed curve with curvature greater than zero, the derivative with respect to arc length of the unit binormal vector is given by:

$$\frac{\partial B}{\partial l} = - τ N \qquad ( 10 )$$

Where:
τ is the torsion of the curve; and
N is the unit principal normal vector.

Based on this and on Eq. 6, we can express the derivative of the binormal vector with respect to angular frequency as:

$$\frac{\partial B}{\partial ω} = - t τ N \qquad ( 11 )$$

So, the second order PMD vector may be expressed as:

$$\frac{\partial Ω}{\partial ω} = ( \frac{\partial t}{\partial ω} k + t \frac{\partial k}{\partial ω} ) B - {t}^{2} k τ N \qquad ( 12 )$$

It will be understood by one skilled in the relevant arts that higher order PMD vectors may be computed by taking further derivatives of Eq. 12. In most instances, this will not be necessary, as the first and second order PMD vectors will provide sufficient accuracy.

According to the fundamental theorem of space curves, for a given single valued continuous curvature function and single valued continuous torsion function, there exists exactly one corresponding space curve, determined except for its orientation and translation. Thus, the shape of the curve (determined by curvature and torsion) only partially determines the PMD vector, since the same curve can give different PMD vectors, depending on its orientation. However, if the tangent vector is also known, then the PMD vectors can be completely determined.

It will be recognized that the PMD vectors computed by the methods of the present invention are approximations. However, due to the generally high accuracy of these approximations, and the rapid speed with which the required measurements are taken, the approximations made by the methods of the present invention may often be more accurate than calculations of the PMD vectors made by other methods that require multiple input polarization states, which lose accuracy due to slow measurement speed and other interference.

Referring now to FIG. 5, the steps taken to compute approximations of the first order and second order PMD vectors in accordance with the present invention are described. In step 500, a light beam with a fixed input polarization state is introduced to a device under test (DUT). At step 510, a measurement is taken of the output polarization state of the light beam, after it has passed through the DUT. The measurement is either received or translated into Stokes space, as a point on the Poincaré sphere. Steps 500 and 510 are repeated for numerous light beams, each having the same fixed polarization state, but varying frequencies. In some embodiments, the frequencies vary in linear steps from a first predetermined frequency to a second predetermined frequency. These measurements for the light beams provide points on the curve that is analyzed to provide the PMD vectors.

Next, in step 520, the analysis device applies the formula in Eq. 8 to compute the first order PMD vector: Ω(ω)=t(ω)k(ω)B(ω). As will be understood, since only points on the curve are available from the measurements, the tangent, curvature, and binormal vector are estimated numerically, using known numerical techniques. Their product is used to compute the first order PMD vector.

In step 530, the analysis device applies the formula in Eq. 12 to compute the second order PMD vector:

$$\frac{\partial Ω}{\partial ω} = ( \frac{\partial t}{\partial ω} k + t \frac{\partial k}{\partial ω} ) B - {t}^{2} k τ N$$

### As with the first order PMD vector, known numerical techniques are used to estimate the curvature, torsion, tangent, principal normal vector and binormal vector, given points on the curve.

Finally, in step 540, the analysis device provides the PMD vectors as output. This output may serve as input to other applications, such as graphing applications, optical design applications, or applications designed to compensate for PMD.

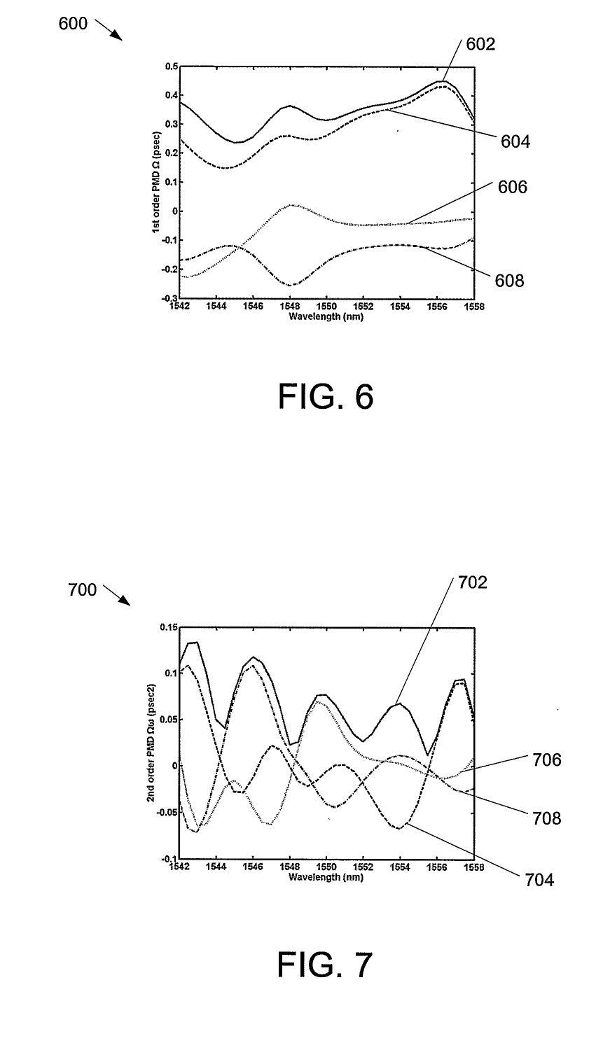

FIG. 6 shows an example plot 600 of the first order PMD vector, as computed by the techniques of the present invention, for a 110 km single-mode fiber. The solid curve 602 shows the magnitude, while the curves 604, 606, and 608 show the three components of the first order PMD vector. Similarly, FIG. 7 shows a plot 700 of the second order PMD vector. As before, the solid curve 702 shows the magnitude, while the curves 704, 706, and 708 show the three components of the second order PMD vector.

While the invention has been shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes that come within the meaning and range of equivalency of the claims are intended to be embraced.

What is claimed is:

1. A method for determining polarization mode dispersion (PMD) for an optical device under test (DUT), the method comprising:
inserting into the DUT a plurality of light beams, each light beam in the plurality of light beams having the same predetermined fixed polarization state, the plurality of light beams having frequencies that vary over a range;
determining an output polarization state for each light beam in the plurality of light beams;
calculating a first order PMD vector based at least in part on the shape of a curve in Stokes space formed by the output polarization states of the plurality of light beams; and
calculating a second order PMD vector based at least in part on the shape of the curve in Stokes space.

2. The method of claim 1, wherein the curve in Stokes space lies on the surface of a Poincaré sphere.

3. The method of claim 1, wherein calculating the first order PMD vector comprises computing the curvature of the curve.

4. The method of claim 1, wherein calculating the first order PMD vector comprises computing the magnitude of the tangent of the curve.

5. The method of claim 1, wherein calculating the first order PMD vector comprises computing the binormal vector of the curve.

6. The method of claim 1, wherein calculating the first order PMD vector comprises applying the formula:
Ω(ω)=t(ω)k(ω)B(ω)
where Ω(ω) is the first order PMD vector, t(ω) is the magnitude of the tangent of the curve, k(ω) is the curvature of the curve, and B(ω) is the binormal vector of the curve.

7. The method of claim 1, wherein calculating the first order PMD vector comprises parameterizing the curve by its arc length.

8. The method of claim 1, wherein calculating the second order PMD vector comprises computing the torsion of the curve.

9. The method of claim 1, wherein calculating the second order PMD vector comprises computing the principal normal vector of the curve.

10. The method of claim 1, wherein calculating the second order PMD vector comprises applying the formula:
$$\frac{\partial Ω}{\partial ω} = ( \frac{\partial t}{\partial ω} k + t \frac{\partial k}{\partial ω} ) B - {t}^{2} k τ N$$
where k is the curvature of the curve, t is the magnitude of the tangent of the curve, τ is the torsion of the curve, N is the principal normal vector of the curve, and B is the binormal vector of the curve.

11. Apparatus for determining polarization mode dispersion (PMD) for an optical device under test (DUT), comprising:
a tunable laser that provides a light beam at a selectable frequency;
a fixed polarizer that polarizes the light beam in a predetermined fixed input polarization state prior to injecting the light into a device under test (DUT);
a measurement device that measures the output polarization state of the light beam that has passed through the DUT; and
an analysis device that collects measurements from the measurement device for a plurality of light beams at varied frequencies, and that calculates a first order PMD vector based at least in part on the shape of a curve in Stokes space formed by the output polarization states of the plurality of light beams, and calculates a second order PMD vector based at least in part on the shape of the curve in Stokes space.

12. The apparatus of claim 11, wherein the analysis device comprises a computer programmed to calculate the first order PMD vector and the second order PMD vector.

13. The apparatus of claim 11, wherein the fixed polarizer is a portion of the tunable laser.

14. The apparatus of claim 11, wherein the DUT comprises a single-mode optical fiber.

15. The apparatus of claim 11, wherein the curve in Stokes space lies on the surface of a Poincaré sphere.

16. The apparatus of claim 11, wherein the analysis device calculates the first order PMD vector using the curvature of the curve.

17. The apparatus of claim 11, wherein the analysis device calculates the first order PMD vector using the formula:
Ω(ω)=t(ω)k(ω)B(ω)
where Ω(ω) is the first order PMD vector, t(ω) is the magnitude of the tangent of the curve, k(ω) is the curvature of the curve, and B(ω) is the binormal vector of the curve.

18. The apparatus of claim 11, wherein the analysis device calculates the second order PMD vector using the torsion of the curve.

19. The apparatus of claim 11, wherein the analysis device calculates the second order PMD vector using the formula:
$$\frac{\partial Ω}{\partial ω} = ( \frac{\partial t}{\partial ω} k + t \frac{\partial k}{\partial ω} ) B - {t}^{2} k τ N$$
where k is the curvature of the curve, t is the magnitude of the tangent of the curve, τ is the torsion of the curve, N is the principal normal vector of the curve, and B is the binormal vector of the curve.

20. A method of determining a first order polarization mode dispersion vector and a second order polarization mode dispersion vector for an optical device, the method comprising:
passing light having a fixed input polarization state and varying frequency through the optical device;
measuring the output polarization state of the light that has passed through the optical device;
creating a curve on a Poincaré sphere by tracing the output polarization state of the light on the Poincaré sphere as the frequency of the light is varied from a first frequency to a second frequency;
computing the first order polarization mode dispersion vector based at least in part on the curvature of the curve; and
computing the second order polarization mode dispersion vector based at least in part on the curvature and torsion of the curve.
